(19) United States
(12) Patent Application Publication
(10) Pub. No.: US 2009/0260635 A1
(43) Pub. Date: Oct. 22, 2009

(54) Fragrance masks

(76) Inventor: Mary Dean, Gardena, CA (US)

Correspondence Address: RUTH EURE, 4795 EDISON AVENUE, BOULDER, CO, 80301, US

(21) Appl. No.: 12/319,402

(22) Filed: Jan. 7, 2009

Related U.S. Application Data
(60) Provisional application No. 61/124,366, filed on Apr. 16, 2008.

(51) Int. Cl. A62B 18/08

(52) U.S. Cl. 128/863; 128/206.21

(57) ABSTRACT

A specially designed face mask is provided which provides an impenetrable barrier between the wearer and noxious odors. Manufactured of any suitable material, such as durable, disposable paper, fabric, woven or felted material, for example, the fragrance face mask of the present invention is essentially rectangular in shape. The mask provides fragrance to block unwanted odors alone or in combination with anti-bacterial, anti-microbial or anti-fungal agents.

### CLAIM OF PRIORITY

Applicant claims priority for this patent application from U.S. provisional patent application Ser. No. 61/124,366, filed Apr. 16, 2008, of common inventorship herewith.

### FIELD OF THE INVENTION

The present invention pertains to the field of face masks, and specifically for face masks for medical and dental personnel and more specifically to the field of fragrance face masks.

### BACKGROUND OF THE INVENTION

The problem of odors in face masks has been addressed by the prior art in several ways.

U.S. Pat. No. 4,503,851 to Braunroth describes a disposable face mask having an odor masking attachment.

U.S. Pat. No. 5,243,708 to Vanuch describes a disposable scented mask having a thickened mouthpiece portion adapting the mask to be held in place while clutched in the mouth or teeth.

U.S. Pat. No. 5,538,013 to Brannon describes a mask having interchangeable scenting means. The face mask of this reference utilizes a triangular molded portion for fitting over the mouth and nose of the wearer.

None of the prior art devices solve the problem of noxious and unpleasant odors in the same manner as the present invention.

### SUMMARY OF THE INVENTION

It is an object of the present invention to provide a face mask which provides an impenetrable barrier between the wearer and noxious odors.

It is an object of the present invention to provide a face mask for medical and dental personnel which provides an impenetrable barrier between the wearer and noxious odors.

It is a further object of the present invention to provide a face mask which provides a pleasant fragrance to the wearer.

It is a further object of the present invention to provide a face mask which provides fragrance and which is easy to manufacture.

It is a further object of the present invention to provide a face mask which provides fragrance and is compact for storage and shipping.

It is a further object of the present invention to provide a face mask which provides fragrance and fits a wide variety of facial structures.

It is a further object of the present invention to provide a face mask which provides means for imparting aroma therapy agents to induce relaxation, mental stimulation, or any other desired emotional effect.

It is a further object of the present invention to provide a face mask which provides fragrance is economical to the consumer and the manufacturer.

It is a further object of the present invention to provide a face mask which provides fragrance and which is disposable.

It is a further object of the present invention to provide a face mask which provides an antibacterial, antimicrobiual or anti-fungal solution, singly or in combination.

### BRIEF DESCRIPTION OF THE DRAWINGS

FIG. 1 shows a face mask of the present invention.

FIG. 2 shows an alternative embodiment of the face mask of the present invention.

FIG. 3 shows the face mask of the present invention being worn by a user.

### DETAILED DESCRIPTION OF THE INVENTION

As used herein the term “fragrance” refers to any substance, liquid, powder or any other form which elicits an olfactory response in humans.

Millions of consumers are employed in fields which leave them vulnerable to exposure of noxious odors and harmful airborne agents. Whether a dentist who encounters the unpleasant odor of bad breath and rotting teeth, a nursing assistant who must care for her patient's most basic bodily functions, or a sanitation worker who spends long hours standing on a garbage truck platform, regular exposure to pungent odors, germs and bacteria is simply unavoidable for many professionals. In addition, many household consumers come face to face with foul odors on a daily basis. The simple act of emptying a pet's litter box, scrubbing a toilet or even cleaning up after a sick child, can leave one feeling queasy and miserable as a result of inhaling foul odors.

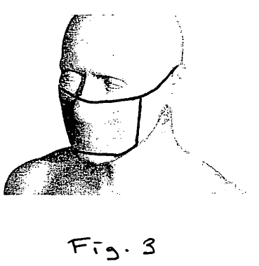

This invention pertains to fragrance face masks and more specifically to face masks for medical and dental personnel. The present invention provides consumers a practical solution to the aforementioned problems. As the name implies, this invention is a specially designed surgical mask designed specifically to provide an impenetrable barrier between the wearer and noxious odors. Manufactured of any suitable material, such as durable, disposable paper, fabric, woven or felted material, for example, the fragrance face mask of the present invention is essentially rectangular in shape. Produced in a one size fits all standard, this invention comprises lightweight, ear loops 12 comprised of elastomeric material such as elastic, for example, attached to both ends of the mask at the corners and designed to facilitate attachment of the unit to the face by looping the ear straps over the ears of the wearer. This can be seen in FIG. 3.

The rectangular face mask has corners, (a), (b) (c) and (d). The ear loops are formed by attaching one end of the loop to each corner forming a loop that can be stretched around each ear of the user. Specifically, the first end of the first loop attaches to corner (a). The second end of the first loop attaches to corner (b). The first end of the second loop attaches to corner (c). The second end of the second loop attaches to corner (d). The attachment of the ends of the loops to each corner of the mask creates two ear loops, one on each end of the mask.

A novel feature of the present invention is the scented strip 14. The scented strip is positioned in the approximate center of the unit, directly below the position of the nose. The scented strip is effused with a delightful fresh fragrance, serving to neutralize noxious odors before they can be inhaled by the wearer. Considerations for this fragrance could range from soft baby powder, tangy citrus or spicy cinnamon to flowery gardenia and earthy sandalwood, to name only a few options.

If desired, the strip can provide means for imparting aroma therapy agents such as essential oils, for example, to induce relaxation, mental stimulation, or any other desired emotional effect.

The scented strip could also employ any combination of anti-bacterial, anti-microbial or anti-fungal agents, as desired.

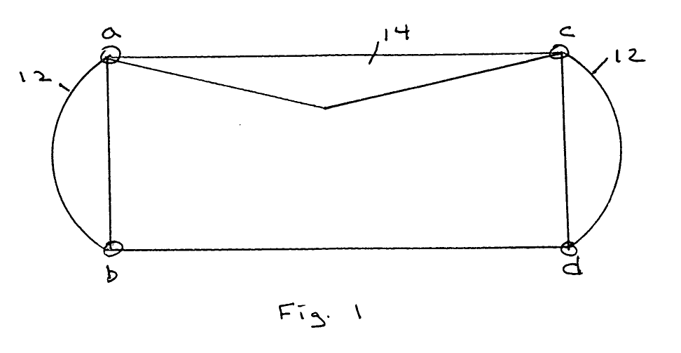

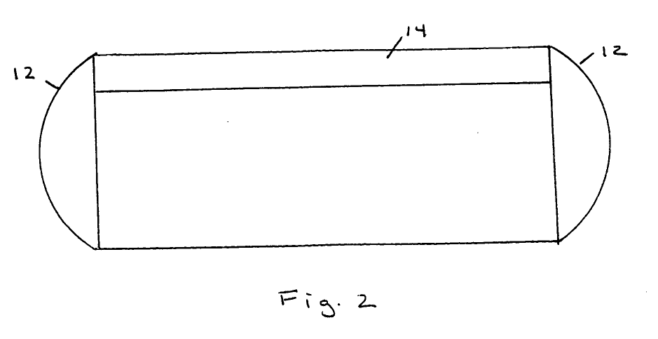

The scented strip could be made from any material suitable for absorbing fragrance or other fluid and affixed to the internal side of the face mask below the nose area. Any means for affixing the strip could be utilized, such as adhesive, such as isotactic polypropylene, for example, or sewing. The shape of the strip can be any suitable shape or configuration which would be sufficient to receive the fragrance solution. For example, the shape can be triangular, as shown in FIG. 1, or rectangular, as shown in FIG. 2.

Additionally, an anti-bacterial, anti-microbial, or anti-fungal agent can be incorporated along with the fragrance to further protect the wearer from pathogens.

Alternatively, the anti-bacterial, anti-microbial, or anti-fungal solution can be incorporated without the fragrance to further protect the wearer from pathogens for wearers sensitive to fragrance.

If sterility is required, each fragrance mask could be individually wrapped for sterility.

Use of the fragrance mask of the present invention very simple and straightforward. First, the user would remove a unit from its protective packaging. Placing the mask over the nose and mouth, the user would secure the integrated elastic ear straps over and behind each ear. After positioning the mask over the nose, the user would make any final adjustments necessary for comfort. Once donned, the mask covers the face from the nose to the base of the chin. While the user is wearing the mask, the scented nose strip would work to reduce or eliminate any odors the user may encounter, while the antibacterial, antimicrobial or antifungal solution would kill germs, bacteria and molds on contact. After use, the fragrance masks could be discarded in any waste basket or garbage receptacle.

There are several significant benefits and advantages associated with this unique product invention. Foremost, the Fragrance Masks would provide consumers with a simple and effective way to battle the unpleasant odors they may confront when on the job. A cleverly enhanced surgical mask, this product would allow the user to work in odiferous environments in a comfortable, easy manner. Containing a variety of fragrances in a concentrated form, from fruity smells such as strawberry and peaches to earthy scents like mountain breeze and rain water, a donned Fragrance Mask would dispense an attractive and aromatic scent for hours. Simple in its construction and easy to apply, this mask could be just as easily put on as it could be taken off, in just a matter of seconds. While the Fragrance Mask was primarily conceived with medical professionals in mind, maintenance workers and general household consumers should appreciate the many benefits this useful product would afford.

The Fragrance Mask of the present invention makes the unpleasant tasks faced by many professionals much easier to complete. Comfortable to wear and disposable, this unique surgical mask could prove an invaluable commodity to a wide range of consumers.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A fragrance face mask comprising:
A.) an essentially rectangular face mask having corners (a), (b), (c) and (d);
B.) a piece of elastomeric material having a first end and a second end wherein the first end of elastomeric material is attached to the rectangular face mask at corner (a) and the second end of elastomeric material is attached to the rectangular face mask at corner (b);
C.) a second piece of elastomeric material having a first end and a second end wherein the first end of the second piece of elastomeric material is attached to the rectangular face mask at corner (c) and the second end of the second piece of elastomeric material is attached to the rectangular face mask at corner (d);
D.) a fragrance strip attached to the inside of the rectangular face mask.

2. The fragrance face mask of claim 1 wherein the elastomeric material is elastic.

3. The fragrance face mask of claim 1 wherein the fragrance strip is triangular.

4. The fragrance face mask of claim 1 wherein the fragrance strip is rectangular.

5. The fragrance face mask of claim 1 wherein the fragrance strip is placed near the top of the rectangular face mask.

6. The fragrance mask of claim 1 wherein the fragrance strip is impregnated with fragrance.

7. The fragrance mask of claim 1 wherein the fragrance strip is impregnated with fragrance and an agent selected from the group consisting of: antimicrobial, antibiotic and antifungal agents.

8. The fragrance mask of claim 1 wherein the fragrance strip is impregnated with an agent selected from the group consisting of: antimicrobial, antibiotic and antifungal agents.

9. The fragrance mask of claim 1 wherein the fragrance strip is impregnated with an aroma therapy agent.

10. The fragrance mask of claim 1 wherein the fragrance strip is impregnated with a more than one aroma therapy agent.

11. The fragrance mask of claim 1 wherein the fragrance strip is impregnated with one or more aroma therapy agents and one or more agents selected from the group consisting of: antimicrobial, antibiotic and antifungal agents.
